(19) United States
(12) Patent Application Publication
(10) Pub. No.: US 2026/0342560 A1
(43) Pub. Date: Oct. 29, 2026

(54) SLIDING-WINDOW BASED ORDER RELAXATION FOR ENCRYPTED CHANNEL BASED ON FINE-GRAINED STATE TRACKING

(71) Applicant: Hewlett Packard Enterprise Development LP, Spring, TX (US)

(72) Inventors: Derek Alan Sherlock, Ft. Collins, CO (US); Frank R. Dropps, Annandale, MN (US); Keith D. Underwood, Powell, TN (US)

(21) Appl. No.: 19/315,346

(22) Filed: Aug. 29, 2025

Related U.S. Application Data
(60) Provisional application No. 63/795,769, filed on Apr. 28, 2025.

(51) Int. Cl. H04L 9/08

(52) U.S. Cl. CPC H04L 9/088

(57) ABSTRACT

A requester generates a full initial value (IV) associated with encryption of round-trip communications with a responder, the full IV comprising most significant bits (MSBs) indicating a requester epoch value to be incremented sequentially by the requester and least significant bits indicating a transaction number to be updated non-sequentially by a free-space tracker. The requester sends to the responder a request comprising the transaction number. The requester maintains a first state machine for each transaction number in an epoch, the first state machine tracking request issuance and response status for a respective transaction number across multiple epochs. The requester identifies, based on the first state machine, a sliding window associated with: two active epochs including one even epoch and one odd epoch. The requester advances the sliding window by setting an oldest active epoch to an inactive epoch and by setting an inactive next epoch to an active epoch.

### RELATED APPLICATION

This application claims the benefit of U.S. Provisional Patent Application No. 63/795,769, entitled “SLIDING-WINDOW BASED ORDER RELAXATION FOR ENCRYPTED CHANNEL,” by Derek Alan Sherlock, Frank R. Dropps, and Keith D. Underwood, filed on 28 Apr. 2025.

### BACKGROUND

Some developing network fabric specifications use an encryption protocol that requires in-order delivery of messages. For example, the AES-GCM-256 protocol uses a shared key and a unique initial value (IV) for encrypted operations between a requester and a responder. While the key may be used repeatedly, reusing the IV with the same key may weaken security by creating a vulnerability to cryptographic attack. The IV may be generated by the requester and transmitted in plaintext, i.e., full-length IV transmission. The IV may also be maintained by both the requester and the responder, e.g., based on a synchronized counter which requires in-order message delivery.

### BRIEF DESCRIPTION OF THE FIGURES

FIG. 1 illustrates an environment which facilitates sliding-window based order relaxation for an encrypted channel based on a two-epoch system, in accordance with an aspect of the present application.

FIG. 2A illustrates a bit-field chart depicting a full IV maintained by a requester, in accordance with an aspect of the present application.

FIG. 2B illustrates a bit-field chart depicting a partial IV maintained by a responder, in accordance with an aspect of the present application.

FIG. 2C illustrates a diagram of hardware or data structures maintained by a requester, in accordance with an aspect of the present application.

FIG. 2D illustrates a diagram of hardware or data structures maintained by a responder, in accordance with an aspect of the present application.

FIG. 3 illustrates a diagram of the operations of a requester in sending requests and receiving responses based on a two-epoch sliding window, in accordance with an aspect of the present application.

FIG. 4A illustrates a diagram of per-encoding states tracked by a requester and a sliding window with an active current (odd) epoch and an active prior (even) epoch, in accordance with an aspect of the present application.

FIG. 4B illustrates a diagram of a first state machine with four states maintained by a requester and a second state machine with two states maintained by a responder, in accordance with an aspect of the present application.

FIG. 5A presents a flowchart illustrating a method which facilitates sliding-window based order relaxation for an encrypted channel based on a two-epoch system, including operations by a requester, in accordance with an aspect of the present application.

FIG. 5B presents a flowchart illustrating a method which facilitates sliding-window based order relaxation for an encrypted channel based on a two-epoch system, including operations by a responder, in accordance with an aspect of the present application.

FIG. 5C presents a flowchart illustrating a method which facilitates sliding-window based order relaxation for an encrypted channel based on a two-epoch system, including operations by a responder, in accordance with an aspect of the present application.

FIG. 6 illustrates a computing system which facilitates sliding-window based order relaxation for an encrypted channel based on a two-epoch system, in accordance with an aspect of the present application.

FIG. 7 illustrates a computer-readable medium which facilitates sliding-window based order relaxation for an encrypted channel based on a two-epoch system, in accordance with an aspect of the present application.

In the figures, like reference numerals refer to the same figure elements.

### DETAILED DESCRIPTION

Aspects of the present application provide a system which facilitates sliding-window based order relaxation for an encrypted channel based on a two-epoch system.

As described above, some developing network fabric specifications use an encryption protocol that requires in-order delivery of messages. For example, the AES-GCM-256 protocol uses a shared key and a unique initial value (IV) for each encryption operation between a requester and a responder. While the key may be used repeatedly, reusing the IV with the same key may weaken security by creating a vulnerability to cryptographic attack. Current solutions exist to ensure that the requester and responder use the same key and IV value for encryption and decryption of a single message (e.g., request or response) sent between the requester and responder. In one solution, the requester may generate and transmit the IV in plaintext to the responder, resulting in full-length IV transmission. However, the transmission of full-length IV values with every message may incur significant bandwidth overhead. In another solution, the IV may be maintained by both the requester and the responder as a synchronized counter. With synchronized counters, in-order message delivery is needed to ensure that the IV counters maintained by the requester and the responder remain in sync. However, in-order delivery may consume extra network resources or unacceptably constrain the use of multiple parallel network paths, especially in large-scale high-performance computing (HPC) and artificial intelligence (AI) networks.

The described aspects provide a system which relaxes these in-order delivery constraints while maintaining a secure, encrypted channel for roundtrip communications between a requester and a responder over a network fabric that does not require the transmission of full-length IV values. The requester and responder continue to use a shared key and a common IV for encrypted communication. However, instead of sending the full IV with each request, the requester transmits a request with only a subset of the full IV, such as a number of the least significant bits (LSBs) (referred to as “IV-LSB”), in a protocol layer header field (the “Tag” field), while the responder may reconstruct the full IV by combining the received IV-LSB with its own counter which tracks the remaining most significant bits (“IV-MSB”). This Tag field may already be included as part of the header and thus does not require any additional bits to be transmitted in the roundtrip communications between the requester and the responder. As a result, this “Tag for IV-LSB approach” may reduce bandwidth overhead by transmitting less IV data while allowing for out-of-order message delivery. The responder may encrypt its response using the shared key and reconstructed IV, without transmitting any IV bits back, which allows the requester and responder to use almost the same IV for encryption/decryption and ensure that their respective counters remain in sync while only the requester transmits only a portion of the full IV. Because an IV value should never be repeated for the same encryption key, the IV value used by the requester and responder will differ by a high order IV bit. For example, the MSB of the IV may be “0” for requester encryption and responder decryption and may be “1” for responder encryption and requestor decryption. This arrangement may be understood by both the requester and responder, thereby eliminating the need to exchange this information. There is no loss in functionality or security if any other IV bit is selected or if the information is exchanged.

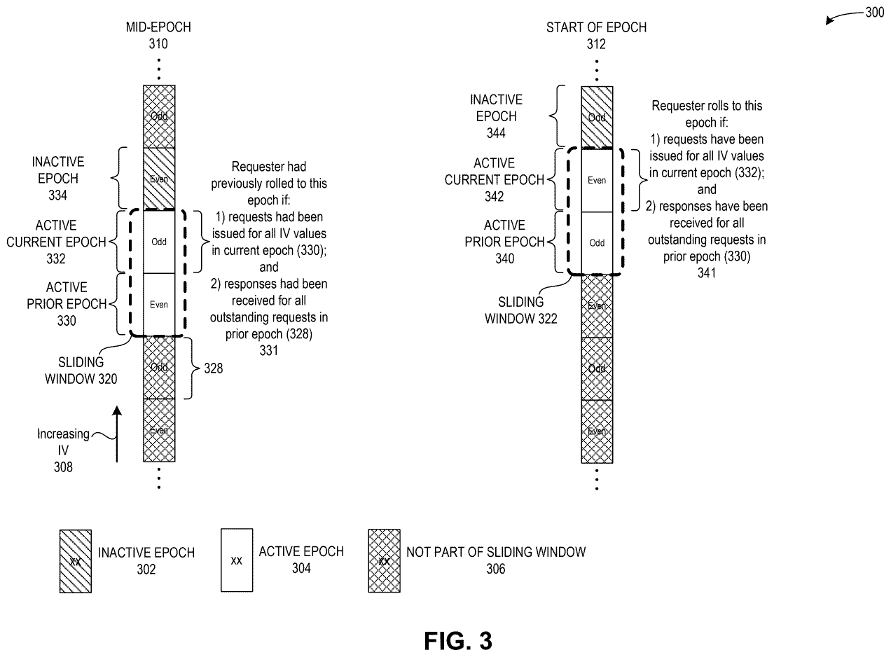

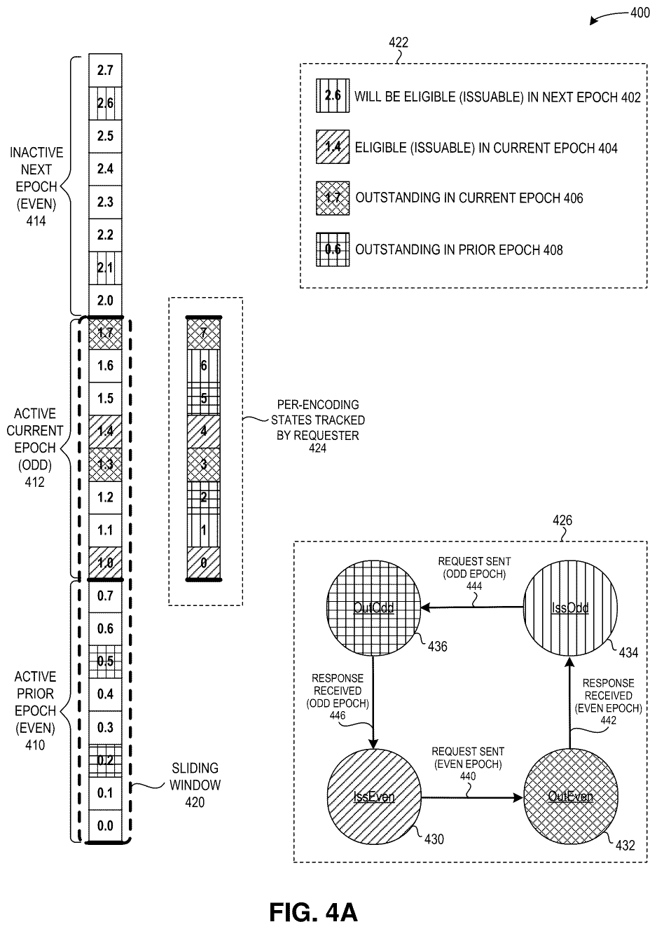

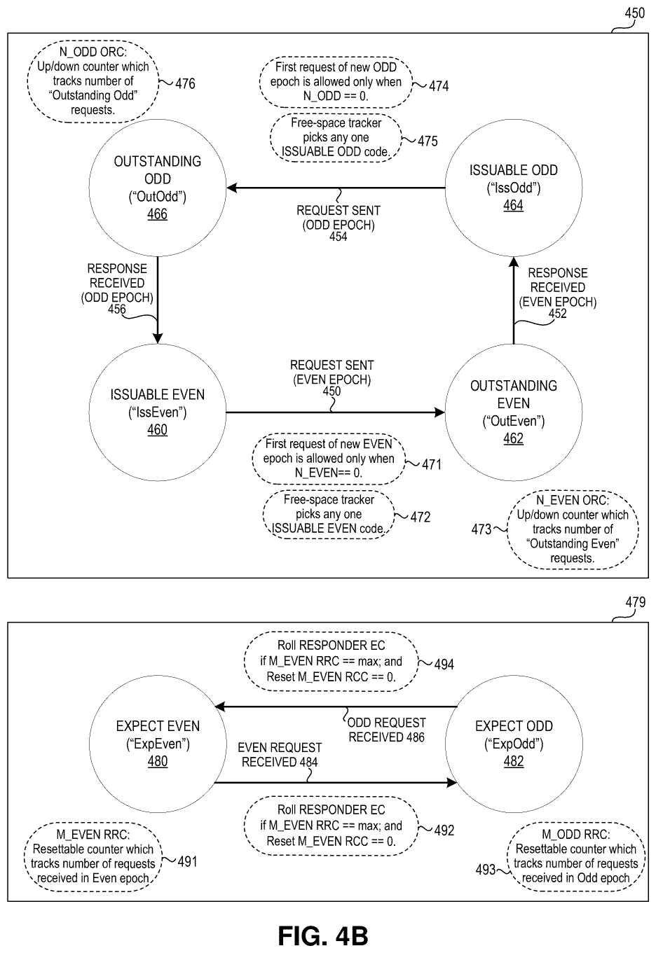

In the described aspects, both the requester and the responder may use certain bits of the IV-MSB as an “epoch identifier” (also referred to as “epoch-identifying bits”), which define a time window for a predetermined number of requests. For example, using the least significant bit of the IV-MSB as the epoch identifier in a “two-epoch system” along with the state machine described below in relation to FIGS. 4A-B, the requester may manage a sliding window associated with two “active epochs”. An active epoch may correspond to a time window in which a maximum number of requests are currently allowed to be sent. In the two-epoch system, the requester may identify and advance a sliding window with two epochs based on a set of conditions, and requests and responses may be exchanged across two active epochs simultaneously, as described below in relation to FIG. 3.

It will be apparent to those skilled in the art that the two-epoch scheme may be extended to greater numbers of epochs, for example four or more, with a corresponding increase in the width of the epoch identifier.

The Tag field may be, e.g., an 11-bit header field, for uniquely identifying and matching a request with a corresponding response (for the protocol layer), while the IV-LSB may be used to reconstruct a full IV for encryption and decryption of a roundtrip request/response communication between the requester and the responder (for the security layer). The described aspects provide a system which uses the Tag field to include an IV-LSB value that may serve double-duty for both the security and protocol layers (the “Tag for IV-LSB approach”).

The IV may generally be a sequentially increasing counter value that defines the value of the sequentially-assigned encodings in each epoch. However, using sequentially assigned-encodings may impact performance when placing the IV-LSB in the Tag field in a two-epoch system. For example, the responder may not be able to disambiguate IV-LSBs with the same value, i.e., cannot clearly identify the epoch in the sliding window with which the IV-LSB is associated, which would limit the number of concurrent outstanding requests to, e.g., half of the 2¹¹ possible encodings in the Tag field.

Furthermore, the Tag and the IV-LSB may have similar but slightly different uniqueness requirements. The Tag and the IV values may be unique for their respective purposes (e.g., protocol layer and security layer), but both usages may allow the actual order of issuing the encodings to differ from strict numerical order, i.e., does not require sequentially-assigned encodings. Given a maximum number of, e.g., 2¹¹ encodings, the requester may issue a request with an IV-LSB encoding in any order within an epoch, as along as each encoding is used exactly once in each epoch before being reused in the next epoch. The requester may also issue a request with a Tag encoding in any order, but the reuse of a Tag is not based on an epoch and is instead only based on temporal uniqueness (i.e., only one request/response pair may be using the Tag at any given time). As a result, instead of using a sequentially-assigned encoding, the requester may use an IV-LSB/Tag value with values generated by a free-space tracker, e.g., a free bit-vector and priority encoder or a pair of recycling First-In-First-Out (FIFO) queues.

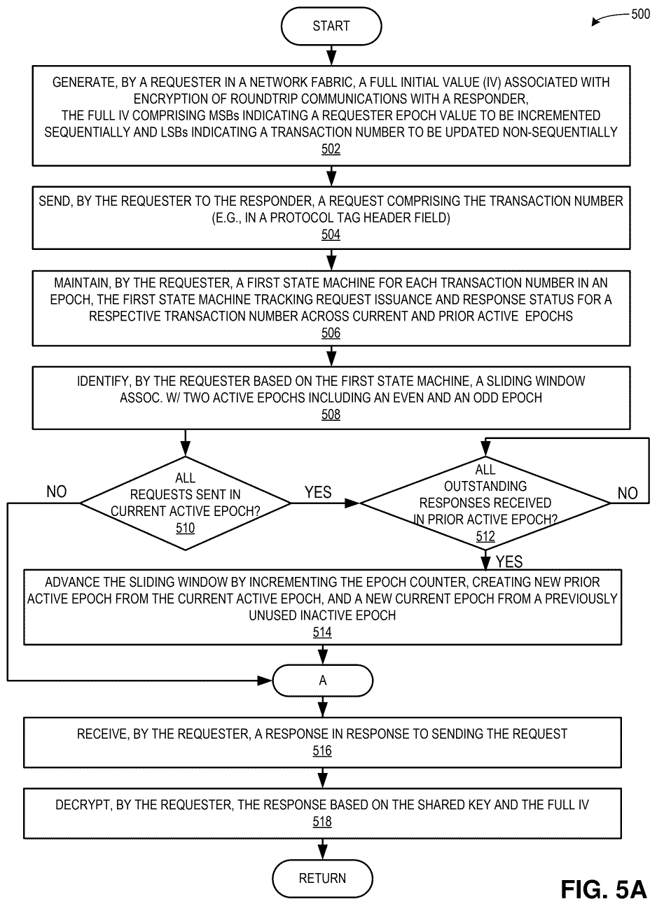

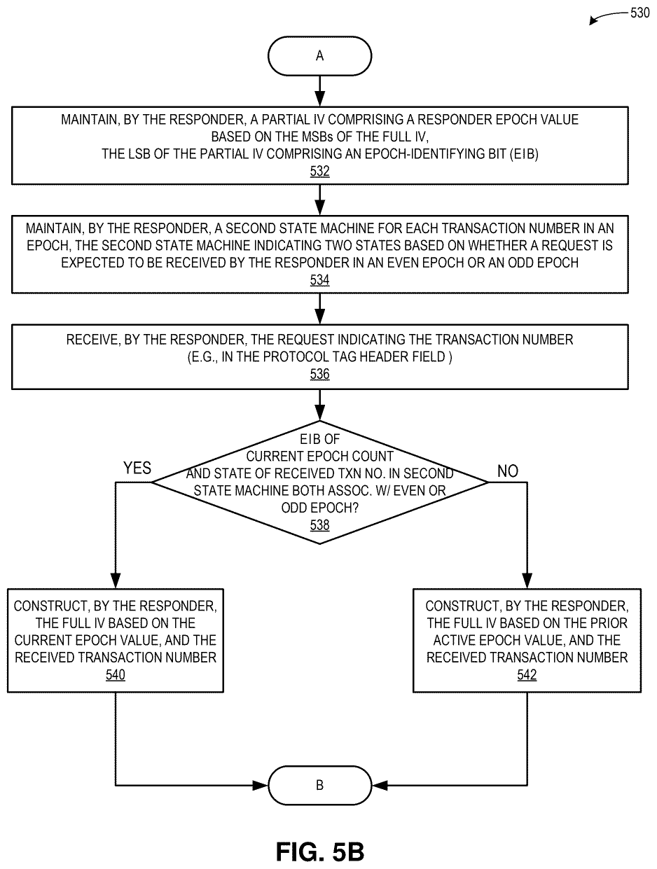

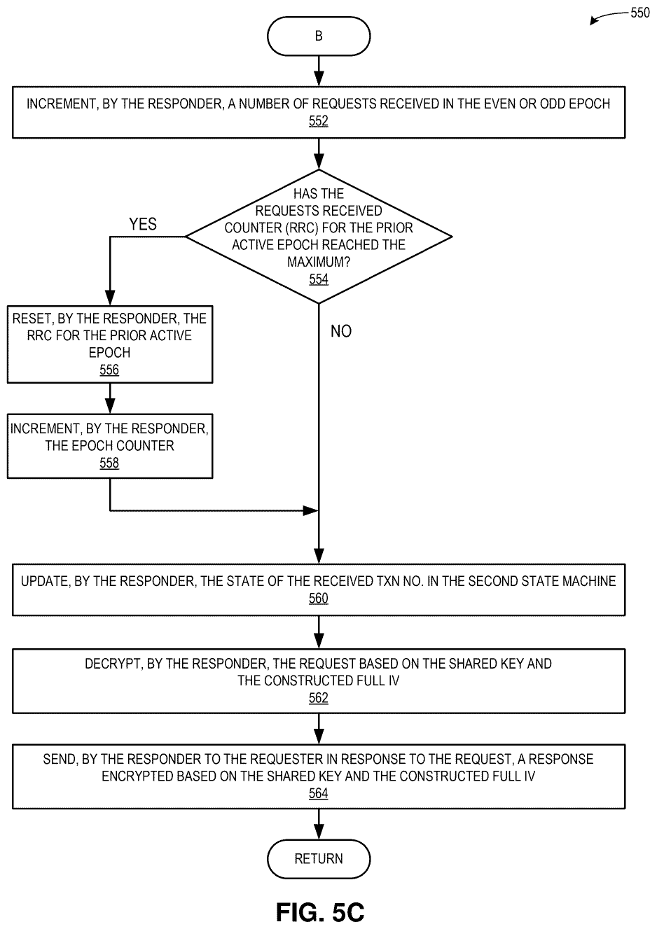

The requester may issue requests using IV-LSB encodings in any order per epoch, while respecting both the protocol layer Tag rules (temporal uniqueness of in-use encodings) and the security layer IV rules (no repetition within an epoch). In the two-epoch system, epoch numbers may alternate between even and odd epochs. For example, assuming an initial start from an even epoch, the requester may “roll the epoch” to an odd epoch by sending new requests in the odd epoch when two conditions have been met: first, all encodings in the 2¹¹ space (i.e., the maximum number) have been used in requests for the current even epoch; and second, all outstanding requests from the previous odd epoch have been retired, even if outstanding requests (with non-conflicting IV encodings) remain in the preceding even epoch. The requester may maintain a state machine with four states per encoding, relating to whether a request with a particular encoding has been issued or is outstanding in an even epoch or an odd epoch. Rolling the requester epoch is described below in relation to FIGS. 3 and 5A-C, and maintaining the state machine is described below in relation to FIGS. 4A-B.

Thus, the requester may maintain a sliding window of allowable concurrently outstanding requests that can use the entire Tag encoding space while spanning up to two consecutive epochs to account for out-of-order retirement. As a result, the issuance of new requests is not stalled by any isolated out-of-order latency outliers.

Furthermore, the responder may disambiguate requests received out of order because requests for any given IV-LSB encoding always arrive at the responder in increasing epoch order. That is, the same IV-LSB encoding is never outstanding concurrently more than once (based on the protocol Tag requirement). The responder may maintain a state machine with two states per encoding, relating to whether the next expected request falls in an even epoch or an odd epoch. The responder may determine whether to roll the responder epoch value based on the current value of its responder epoch value and the state machine. Rolling the responder epoch is described below in relation to FIGS. 3 and 5A-C, and maintaining the state machine is described below in relation to FIG. 4B.

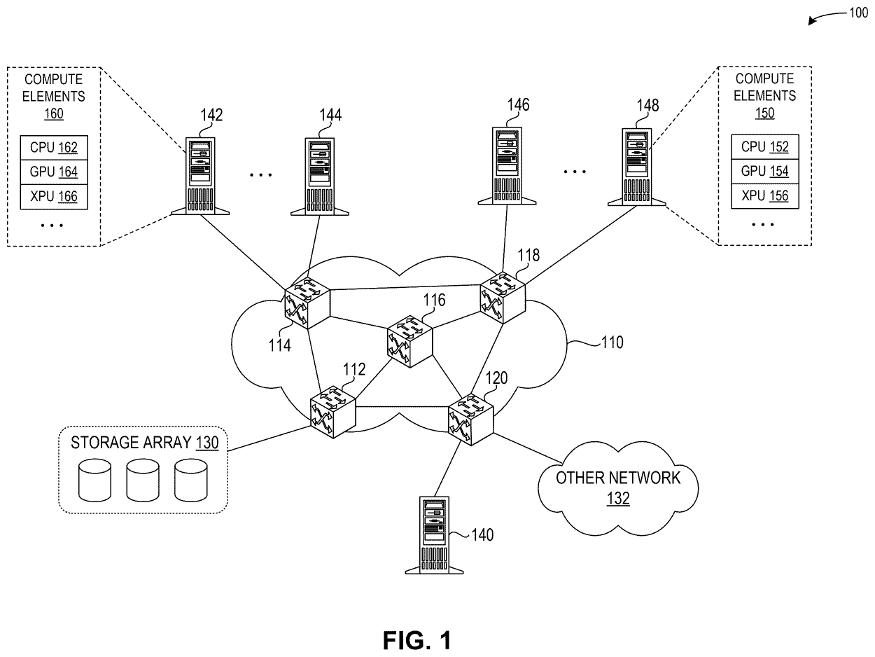

FIG. 1 illustrates an environment 100 which facilitates sliding-window based order relaxation for an encrypted channel, in accordance with an aspect of the present application. Environment 100 can include a network 110 of switches which can be referred to as a “switch fabric” or a “network fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112. Another network 132 (e.g., an HPC, Ethernet, InfiniBand, or any other network) may be coupled to switch fabric 110 via switch 120. Other network 132 may include multiple networked computer and storage devices concurrently running programs to complete different complex and performance-intensive tasks. Other network 132 may include physical Ethernet cabling and an application layer protocol between network devices based on Internet Protocol (IP), including communication via Transport Communication Protocol (TCP)/IP and User Datagram Protocol (UDP) packets. Switch fabric 110 may itself be an Ethernet network, UALink, InfiniBand or an HPC network.

Any number of endpoints, processing nodes, compute elements, or devices with compute elements (collectively referred to as “devices”) may also be coupled to switch fabric 110, e.g.: devices 142 and 144 may be coupled to switch fabric 110 via switch 114; devices 146 and 148 may be coupled to switch fabric 110 via switch 118; and device 140 may be coupled to switch fabric 110 via switch 120. As depicted in FIG. 1, device 148 may include compute elements 150, which may include, e.g.: a central processing unit (CPU) 152; a graphics processing unit (GPU) 154; and an XPU 156, which may be any processing unit, combination of processing units, or specialized processing unit or hardware accelerator designed or optimized for a specific task. Similarly, device 142 may include compute elements 160, which may include, e.g., a CPU 162, a GPU 164, and an XPU 166. Environment 100 may include more or fewer entities coupled to switch fabric 110, and each device may include more or fewer compute elements than those depicted in compute elements 150. The entities coupled to switch fabric 110 may include a requesting node (“requester”) and a responder node (“responder”). A requester may engage in roundtrip communications over a secure encrypted channel with a responder, where each request sent by the requester expects a corresponding response from the responder. Requests and responses may flow between CPU/GPU/XPU blocks in different nodes, e.g., between 162/164/166 CPU/GPU/XPU in node 142 and 152/154/156 CPU/GPU/XPU in node 148.

In general, a switch can have edge ports and fabric ports. An edge port can couple to a device that is external to the fabric. A fabric port can couple to another switch within the fabric via a fabric link. Typically, traffic may be injected into switch fabric 110 via an ingress port of an edge switch and may leave switch fabric 110 via an egress port of another (or the same) edge switch. An ingress link can couple a NIC of an edge device (e.g., an HPC end host) to an ingress edge port of an edge switch. Switch fabric 110 can then transport the traffic to an egress edge switch, which in turn can deliver the traffic to a destination edge device via another NIC. A packet can be forwarded in switch fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110.

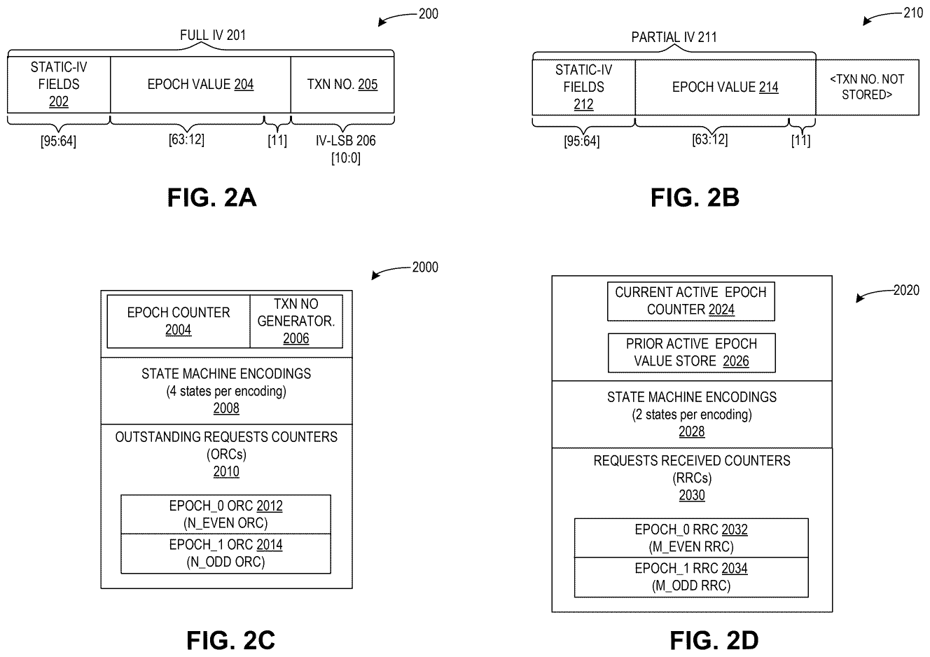

FIG. 2A illustrates a bit-field chart 200 depicting a full IV 201 maintained by a requester, in accordance with an aspect of the present application. The requester may generate full IV 201. Full IV 201 may be generated by or based on a cipher counter (e.g., a Galois counter) and may contain a varying number of bits. For example, full IV 201 may include 96 bits, such as: static-IV fields 202 [95:64]; and a counter-generated epoch field 204 [63:11]; and a transaction number 205 [10:0]. Static-IV fields 202 may include information used by the requester, responder, or other intermediate entity, to process a message associated with full IV 201. Transaction number 205 [10:0] may also be referred to as IV-LSB 206.

Epoch value 204 and transaction number 205 (i.e., IV-LSB 206) may be used to distinguish individual requests with non-sequentially numbered IV-LSBs which have been sent by the requester. Transaction number 205 [10:0] may indicate LSBs [10:0]. Epoch value 204 (i.e., bit [11]) may be referred to as the “epoch identifier” or the “epoch-identifying bit” (EIB) because that IV bit may be used to unambiguously distinguish the epochs of outstanding transactions, from among the two currently active epochs (in a two-epoch system). Active epochs may be sequentially numbered, allowing epochs to be distinguished based on alternating values for the EIB (i.e., “0” indicating an odd epoch and “1” indicating an even epoch). The number of bits used for the transaction number are exemplary, and in this case, chosen to fit the 11-bit size or width of a protocol layer header field in a request message (i.e., the Protocol Tag).

FIG. 2B illustrates a bit-field chart 210 depicting a partial IV 211 maintained by a responder, in accordance with an aspect of the present application. The responder may maintain partial IV 211, which can include: static-IV fields 212 [95:64]; and a responder epoch value 214 [63:11]. The responder epoch value 214 may include as its LSB the epoch-identifying bit [11].

FIG. 2C illustrates a diagram 2000 of hardware or data structures maintained by a requester, in accordance with an aspect of the present application. The requester may include in its hardware: an epoch counter 2004 and a transaction number generator 2006; state machine encodings 2008, which may include four states per encoding in a two-epoch system; and outstanding requests counters (ORCs) 2010 which track the number of requests sent by the requester which are still awaiting a response in a given epoch. ORCs 2010 may include an ORC for each epoch. For example, in a two-epoch system, ORCs 2010 may include: an epoch_0 ORC 2012, which tracks the number of outstanding requests in an even epoch, also referred to as “N_EVEN ORC”; and an epoch_1 ORC 2014, which tracks the number of outstanding requests in an odd epoch, also referred to as “N_ODD ORC.” Since, in this example, outstanding transactions at any given time may only exist in two consecutively-numbered epochs, the epoch numbers of concurrently outstanding transactions may disambiguated by the alternating odd/even value of bit of full IV 201. As such, two ORCs may be sufficient for the requester to track the counts of all outstanding transactions across two active epochs (one odd epoch and one even epoch).

The requester can pick a transaction number upon issuing a new request. If the current active epoch is ODD, the requester may pick any transaction number encoding whose state is Issuable Odd (“IssOdd”), as described below in relation to state 464 in state diagram 450 of FIG. 4B. If no such transaction number exists, and if N_EVEN_ORC is nonzero, the requester must wait; or if N_EVEN_ORC is zero, the requester may roll to the next (even) epoch, and then proceed as described below for EVEN epochs.

If the current active epoch is EVEN, the requester may pick any transaction number encoding whose state is Issuable Even (“IssEven”), as described below in relation to state 460 in state diagram 450 of FIG. 4B. If no such transaction number exists, and N_ODD_ORC is nonzero, the requester must wait; or if N_ODD_ORC is zero, the requester may roll to the next (odd) epoch, and then proceed as described above for ODD epochs.

FIG. 2D illustrates a diagram 2020 of hardware or data structures maintained by a responder, in accordance with an aspect of the present application. The responder may include in its hardware: a “current active epoch” counter 2024, which can generate an epoch value corresponding to the current active epoch (e.g., indicated as bits [63:12] in FIG. 2B); a “prior active epoch” value store 2026 corresponding to the prior epoch; state machine encodings 2028, which may include two states per encoding in a two-epoch system; and requests received counters (RRCs) 2030 which track the number of requests received by the responder in a given epoch. In this disclosure, the term “prior active epoch” may be used interchangeably with the term “oldest active epoch,” and the term “current active epoch” may be used interchangeably with “most recent active epoch.” The bit ranges describing the responder epoch value (as saved in 2024 and 2026 and indicated by responder epoch value 214 in the bit-field chart of FIG. 2B) may refer to bits [63:12] without the bottom 11 bits for illustrative purposes. The actual number of bits used to store the responder epoch value generated by current active epoch counter 2024 may be less than the highest numbered bit depicted for partial IV 211 (e.g., listed as 95, but maintained as 95−11=84). RRCs 2030 may begin at zero, increment upon receiving a request, and reset to zero when the maximum number is reached and an “epoch roll” occurs, as described below in relation to FIGS. 4B and 5C. For example, RRC reset to zero behavior may be achieved by wrapping around assuming the RRC bit width matches the IV LSB width. RRCs 2030 may include an RRC for each epoch. For example, in a two-epoch system, RRCs 2030 may include: an epoch_0 RRC 2032, which tracks the number of requests received in an even epoch, also referred to as “M_EVEN RRC”; and an epoch_1 RRC 2034, which tracks the number of requests received in an odd epoch, also referred to as “M_ODD RRC.”

Hence, as a result of the requester maintaining a per-encoding state and sending requests with non-sequentially updated IV values, and the responder maintaining a per-encoding state and constructing the full IV based on an association with an even or odd epoch, the described system can facilitate sliding-window based order relaxation for an encrypted channel based on a two-epoch system, e.g., by removing the requirement of in-order delivery while ensuring the necessary security (encryption/decryption).

It will be apparent to those skilled in the art that the elements illustrated in FIGS. 2C and 2D may readily be extended to cover implementations supporting a greater numbers of epochs than two, for example four, with a corresponding increase in number of instances of for example outstanding request counters, received request counters, and prior epoch value stores.

FIG. 3 illustrates a diagram 300 of the operations of a requester in sending requests and receiving responses based on a two-epoch sliding window, in accordance with an aspect of the present application. In diagram 300, two snapshots in time (a mid-epoch time 310 and a start of epoch time 312) are depicted with each epoch presented as a specifically shaded rectangle (as in the index depicting patterns 302, 304, and 306) and the full IV increasing in an upward direction (308). Each rectangle is also depicted with the value of the LSB of the requester epoch value (also referred to as the epoch-identifying bit). This epoch-identifying bit (EIB) may indicate whether the epoch is an even epoch (with a value of 0) or an odd epoch (with a value of 1).

During each snapshot, the active epochs of the sliding window are depicted with a bold dashed-line border. In a two-epoch system, the sliding window may be associated with two active epochs (one even epoch and one odd epoch). The active epochs may be depicted with no pattern fill (304), in which the requester may send requests with the maximum number of IV values in any order based on the state for each IV-LSB encoding. An inactive epoch may be depicted with a diagonally right-slanting line pattern (302), which represents that the next epoch which will become current following the next epoch roll operation. Inactive prior epochs may be depicted by a cross-hatch pattern (306).

Mid-epoch time 310 may indicate a snapshot of the two active epochs at a time prior to the start of the next epoch (depicted as time 312). At time 310, a sliding window 320 may include two active epochs: an active even epoch 330; and an active odd epoch 332. For each epoch, the requester may send requests with the maximum number of IV values in any order, e.g., by using a free-space tracker. At time 310, the requester may have previously rolled to active (current) even epoch 332 if: 1) requests were issued for all IV values in the current epoch (at that time, 330); and 2) responses were received for all outstanding requests in the prior epoch (at that time, 328) (as indicated by element 331).

At a time immediately prior to start of epoch time 312, the requester reaches the end of active odd epoch 332 in sliding window 320 (i.e., the requester has sent the predetermined number of requests for the most recent active epoch) and performs a check before rolling to the next epoch. For example, the requester may roll to the next epoch (depicted as inactive even epoch 334 at time 310) if: 1) requests have been issued for all IV values in the current or most recent active epoch (at that time, 332); and 2) responses have been received for all outstanding requests in the prior active epoch (at that time, 330) (as indicated by element 341). If both conditions are true, the requester may increment its requester epoch value and roll the epoch (i.e., “slide the window”) such that a sliding window 322 at time 312 includes an active odd epoch 340 and an active even epoch 342.

It will be apparent to those skilled in the art that the elements illustrated in FIG. 3 may readily be extended to describe implementations supporting a greater numbers of epochs than two, for example four, with a corresponding increase in the number of active epochs within the sliding windows.

FIG. 4A illustrates a diagram 400 of per-encoding states tracked by a requester and a sliding window 420 with an active current (odd) epoch 412 and an active prior (even) epoch 410, in accordance with an aspect of the present application. Epoch 414 may be an inactive next (even) epoch. Although 11-bit IV-LSB examples are used throughout the remainder of these Figures, resulting in 2,048 distinct transaction number values in each epoch, FIG. 4A depicts only eight IV-LSB encodings in each Epoch. This is for drawing convenience only, and the eight encodings should be understood to be a compact representation only.

The requester may track the state of each encoding (424), and the state of each encoding may be one of four possible states, based on a state machine (426 in FIG. 4A and 450 in FIG. 4B). State diagram 426 indicates four possible states for an encoding: an Issuable Even (“IssEven”) state 430 in which a request may be issued in an even epoch for the respective transaction number (depicted with a diagonally right-slanting line pattern); an Outstanding Even (“OutEven”) state 432 in which a request in the even epoch for the respective transaction number has been issued but is still awaiting a response (depicted with a diagonal cross-hatch pattern); an Issuable Odd (“IssOdd”) state 434 in which a request may be issued in an odd epoch for the respective transaction number (depicted with a vertical line pattern); or an Outstanding Odd (“OutOdd”) state 436 in which a request in the odd epoch for the respective transaction number has been issued but is still awaiting a response (depicted with a cross-hatch pattern). The requester may send a request in an even epoch (440), which moves an encoding from IssEven state 430 to OutEven state 432. The requester may receive a response for that request in the even epoch (442), which moves the encoding from OutEven state 432 to IssOdd state 434. The requester may send a request in an odd epoch (444), which moves the encoding from IssOdd state 434 to OutOdd state 436. The requester may receive a response for that request in the odd epoch (446), which moves the encoding from OutOdd state 436 to IssEven state 430.

The requester may track the per-encoding states (424). For illustrative purposes, each of epochs 410-414 depicts eight of the possible, e.g., 2¹¹ encodings of the IV-LSB. Each of the eight possible encodings in depicted epochs 410-414 may be indicated by a square with a particular shaded pattern, as well as a label for reference purposes (e.g., 0-7). The per-encoding states tracked by the requester (424) for the eight depicted encodings may be: encodings 0 and 4 in the IssEven state; encodings 1 and 6 in the IssOdd state; encodings 2 and 5 in the OutOdd state; and encodings 3 and 7 in the OutEven state.

The encodings in 424 are also depicted in the appropriate epoch in which they occur. For example: active prior (even) epoch 410 may include encodings depicted by 0.0-0.7, where encodings 0.2 and 0.5 are in the IssEven state; active current (odd) epoch 412 may include encodings depicted by 1.0-1.7, where encodings 1.0 and 1.4 are in the IssEven state and encodings 1.3 and 1.7 are in the OutEven state; and inactive next (even) epoch 414 may include encodings depicted by 2.0-2.7, where encodings 2.1 and 2.6 are in the IssOdd state.

Per-encoding states tracked by the requester from the perspective of the active current epoch (422) may correspond to the encodings depicted in each epoch, as described above. For example: encoding 2.6 is eligible (issuable) in the next epoch (as indicated by the vertical line pattern 402); encoding 1.4 is eligible (issuable) in the current epoch (as indicated by the diagonally right-slanting line pattern 404); encoding 1.7 is outstanding in the current epoch (as indicated by the diagonal cross-hatch pattern 406); and encoding 0.6 is outstanding in the prior epoch (as indicated by the cross-hatch pattern 408).

FIG. 4B illustrates a diagram of a first state machine 450 with four states maintained by a requester and a second state machine 479 with two states maintained by a responder, in accordance with an aspect of the present application. As described above in relation to state diagram 426 of FIG. 4A, the requester may track the state of each encoding, and the state of each encoding may be one of four possible states (e.g., based on a state machine). First state machine 450 may include four possible states for each encoding: an Issuable Even (“IssEven”) state 460 in which a request may be issued in an even epoch for the respective transaction number if there are no more outstanding requests in the prior even epoch; an Outstanding Even (“OutEven”) state 462 in which a request in the even epoch for the respective transaction number has been issued but is still awaiting a response; an Issuable Odd (“IssOdd”) state 464 in which a request may be issued in an odd epoch for the respective transaction number if there are no more outstanding requests in the prior odd epoch; or an Outstanding Odd (“OutOdd”) state 466 in which a request in the odd epoch for the respective transaction number has been issued but is still awaiting a response.

When an encoding is in IssEven state 460, the requester may send a request in an even epoch (450), which moves the encoding from IssEven state 460 to OutEven state 462. The requester may receive a response corresponding to the request sent in the even epoch (452), which moves the encoding from OutEven state 462 to IssOdd state 464. The requester may maintain a counter N_EVEN ORC 473, an up/down counter which tracks the number of requests in OutEven state 462. The requester may increment N_EVEN ORC after sending a request in the even epoch (e.g., 450), and the requester may decrement N_EVEN ORC after receiving a response to this request in the even epoch (e.g., 452). The first request of a new even epoch is allowed only when N_EVEN ORC has a value of zero (471). The free-space tracker may pick any single encoding in the issuable even state (472) (i.e., IssEven state 460) to be used in the request.

When the encoding is in IssOdd state 464, the requester may send a request in an odd epoch (454), which moves the encoding from IssOdd state 464 to OutOdd state 466. The requester may receive a response corresponding to the request sent in the odd epoch (456), which moves the encoding from OutOdd state 466 to IssEven state 460. The requester may maintain a counter N_ODD ORC 476, an up/down counter which tracks the number of requests in OutOdd state 466. The requester may increment N_ODD ORC after sending a request in the odd epoch (e.g., 454), and the requester may decrement N_ODD ORC after receiving a response to this request in the odd epoch (e.g., 456). The first request of a new odd epoch is allowed only when N_ODD ORC has a value of zero (474). The free-space tracker may pick any single encoding in the issuable odd state (475) (i.e., IssOdd state 464) to be used in the request.

The responder may track the state of each encoding and the state of each encoding may be one of two possible states (e.g., based on a state machine). Second state machine 479 may include two possible states for each encoding: Expect Even (“ExpEven”) state 480; and Expect Odd (“ExpOdd”) state 482. The state of an encoding tracked by the responder may begin in ExpEven state 480. The responder may receive a request for an encoding in an even epoch (484), which moves the encoding from ExpEven state 480 to ExpOdd state 482. The responder may maintain a counter M_EVEN RRC 491, a resettable counter which tracks the number of requests received in an even epoch. The responder may increment M_EVEN RRC after receiving a request in the even epoch as determined by the state of the encoding in the state machine. If M_EVEN RRC is equal to the predetermined maximum number (e.g., 2¹¹), the responder may increment the responder epoch value (i.e., roll the epoch) and reset M_EVEN RRC to a value of zero (492). This reset to zero behavior may be achieved by counter wrap-around, if RRC counter width matches IV-LSB width.

The responder may receive a request for the same encoding in an odd epoch (486), which moves the encoding from ExpOdd state 482 to ExpEven state 480. The responder may maintain a counter M_ODD RRC 493, a resettable counter which tracks the number of requests received in an odd epoch. The responder may increment M_ODD RRC after receiving a request in the odd epoch as determined by the state of the encoding in the state machine. If M_ODD RRC is equal to the predetermined maximum number (e.g., 2¹¹), the responder may increment the responder epoch value (i.e., roll the epoch) and reset M_ODD RRC to a value of zero (494). This reset to zero behavior may be achieved by counter wrap-around, if RRC counter width matches IV-LSB width.

It will be apparent to those skilled in the art that the elements illustrated in FIGS. 4A and 4B may readily be extended to describe implementations supporting a greater numbers of epochs than two, for example four, with a corresponding increase in number states in cases where state names are correlated with epochs.

FIG. 5A presents a flowchart 500 illustrating a method which facilitates sliding-window based order relaxation for an encrypted channel based on a two-epoch system, including operations by a requester, in accordance with an aspect of the present application. During operation, the system generates, by a requester in a network fabric, a full initial value associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by, e.g., a free-space tracker (operation 502). For example, the requester may generate full IV 201, which includes epoch value 204 [63:11] and transaction number 205 (i.e., IV-LSB 206) [10:0]. The requester may increment epoch value 204 sequentially by “rolling” requester epoch value 204 based on determining that two conditions are true: 1) that no encodings are left in an issuable, e.g., even state; and 2) that all outstanding requests have been received for encodings in the prior epoch, e.g., N_ODD ORC is zero (as described above in relation to FIG. 2C). The requester may update the transaction number non-sequentially, e.g., by using a free-space tracker.

The system sends, by the requester to the responder, a request comprising the transaction number (e.g., in a Protocol Tag header field) (operation 504). The requester may send a request encrypted based on the shared key and the full IV, and the request may include the transaction number (i.e., the IV-LSB) in an unencrypted Protocol Tag header field.

The system maintains, by the requester, a first state machine for each transaction number in an epoch, the first state machine tracking request issuance and response status for a respective transaction number across current and prior epochs (operation 506). For example, the requester may maintain a state machine, which may track four states for each encoding, as depicted in requester state diagram 450 of FIG. 4B, including: IssEven state 460; OutEven state 462; IssOdd state 464; and OutOdd state 466. The four states tracked by the state machine are also described above in relation to the per-encoding states tracked by the requester (422 and 424) in FIG. 4A.

The system identifies, by the requester based on the first state machine, a sliding window associated with two active epochs including an even and an odd epoch, a respective active epoch corresponding to a time window in which a maximum number of requests are currently allowed to be sent (operation 508). For example, in FIG. 3, sliding window 320 may be associated with two active epochs: active current (odd) epoch 332; and active prior (even) epoch 330. During the active epochs, the requester may send requests with the maximum number of IV values in any order based on the state for each IV-LSB encoding.

The system determines whether two conditions are true: 1) whether requests have been issued for all transaction numbers in the current active epoch (i.e., the most recent active epoch) (decision 510); and 2) whether all outstanding requests have received a corresponding response in the prior active epoch (i.e., the oldest active epoch) (decision 512). As described above in relation to 331 and 341 of FIG. 3, the requester may roll the requester epoch if the two conditions are satisfied: first, requests have been issued for all IV values in the current active epoch; and second, responses have been received for all outstanding requests in the prior active epoch.

If the first condition is true (i.e., decision 510 yields a YES result) but the second condition is not true (i.e., decision 512 yields a NO result), the requester does not take any action until both conditions are true (depicted by the NO branch back to decision 512). The requester may not roll the requester epoch value (i.e., advance the sliding window) unless both conditions are true, as described above in relation to inactive epochs 334 and 344 in FIG. 3. If both conditions are true (depicted by the YES branch from decision 512), the requester advances the sliding window by incrementing the epoch counter and by creating a new prior active epoch from the current active epoch and a new current epoch from a previously unused inactive epoch (i.e., by setting an oldest active epoch to an inactive epoch and by setting an inactive next epoch to an active epoch) (operation 514), as depicted above in relation to 331 and 341 of FIG. 3.

The operation continues at Label A of FIG. 5B (describing operations by the responder) and subsequently continues at operation 516 after the operations at Label A have completed.

The system receives, by the requester, a response in response to sending the request to the responder (operation 516). The requester may receive a response from the responder in response to a request previously sent to the responder, and the order of the response as transmitted by the responder or received by the requester is not restricted to in-order delivery. The requester may decrement the number of requests awaiting a response in the respective even or odd epoch, depicted as N_EVEN ORC 2012 or N_ODD ORC 2014 in FIG. 2C.

The system decrypts, by the requester, the response based on the shared key and the full IV used by the requester to encrypt the request (operation 518). The response may include the IV-LSB corresponding to request in the Protocol Tag header field, which may be used by the requester to determine that the response corresponds to the previously sent request. The operation returns.

FIG. 5B presents a flowchart 530 illustrating a method which facilitates sliding-window based order relaxation for an encrypted channel based on a two-epoch system, including operations by a responder, in accordance with an aspect of the present application. The system maintains, by the responder, a partial IV comprising a responder epoch value based on the MSBs of the full IV, the least significant bit (LSB) of the partial IV comprising an epoch-identifying bit (EIB) (operation 532). For example, the responder may include in its hardware current active epoch counter 2024, which can generate an epoch value such as epoch value 214 [63:12] in FIG. 2B. Bit may be an epoch-identifying bit (EIB), where a value of 0 indicates an even epoch and a value of 1 indicates an odd epoch. The responder may also store prior active epoch value 2026, as described above in relation to FIG. 2D.

The system maintains, by the responder, a second state machine for each transaction number in an epoch, the second state machine indicating two states based on whether a request is expected to be received by the responder in an even epoch or an odd epoch (operation 534). For example, the responder may maintain a state machine, which tracks two states for each encoding, as depicted in responder state diagram 479 of FIG. 4B, including: ExpEven state 480; and ExpOdd state 482. The two states tracked by the state machine are also described above in relation to the requests received in an even epoch or an odd epoch (484/486) in FIG. 4B.

The system receives, by the responder, the request including the header field indicating the transaction number (e.g., in the protocol Tag header field) (operation 536). The responder may receive an encrypted request with the IV-LSB in the Protocol Tag field, sent by the requester, e.g., as described above in relation to the requests received during active epochs 330/332 at time 310 in FIG. 3.

The system determines whether the epoch-identifying bit (EIB) of the current epoch count (value) and the state of the received transaction number in the second state machine are both associated with an even epoch or an odd epoch (decision 538).

If the EIB and the received IV-LSB state are both associated with an even or an odd epoch (decision 538) (denoted as [EIB, IV-LSB.state]==a[even,even] or [EIB,IV-LSB.state]==a[odd,odd]), the responder constructs the full IV based on the current epoch value and the received transaction number (operation 540). If the EIB and the received IV-LSB state are not both associated with an even or an odd epoch (decision 538) (denoted as [EIB, IV-LSB.state]==a[odd, even] or [EIB,IV-LSB.state]==a[even,odd]), the responder constructs the full IV based on the prior active epoch value and the received transaction number (operation 542). For example, the responder may combine its responder epoch value 214 (and the received transaction number (IV-LSB 206) to construct the full IV. The full IV may include as its MSBs the partial IV and as its LSBs the received transaction number. The operation continues at Label B of FIG. 5C.

FIG. 5C presents a flowchart 550 illustrating a method which facilitates sliding-window based order relaxation for an encrypted channel based on a two-epoch system, including operations by a responder, in accordance with an aspect of the present application. The system increments, by the responder, a number of requests received in the even epoch or the odd epoch (operation 552) and performs a check to determine whether to roll the responder epoch counter. updates, by the responder, the state of the received transaction number in the second state machine (operation 554). For example, the responder may increment M_EVEN RRC or M_ODD RRC based on the result of decision 554, as described above in relation to 492/494 in responder state diagram 479 of FIG. 4B. If the request was associated with an even epoch (i.e., IV-LSB.state is ExpEven), the responder may increment M_EVEN RRC (as in operation 552). If the request was associated with an odd epoch (i.e., IV-LSB.state is ExpOdd), the responder may increment M_ODD RRC (as in operation 552).

The responder determines whether the requests received counter (RRC) for the prior active epoch has reached a predetermined or maximum value (decision 554). For example, in FIG. 4B, the responder may receive a request for an encoding in an even epoch (484), which moves the encoding from ExpEven state 480 to ExpOdd state 482. The responder may maintain a counter M_EVEN RRC 491, a resettable counter which tracks the number of requests received in an even epoch. As described above in relation to operation 552, the responder may increment M_EVEN RRC after receiving a request in the even epoch as determined by the state of the encoding in the state machine. If M_EVEN RRC is equal to the predetermined maximum number (e.g., 2¹¹) (i.e., the RRC for the prior active epoch has reached the maximum, as in decision 554), the responder may reset the RRC for the prior active epoch (operation 556) and increment the responder epoch value (i.e., roll the epoch) (operation 558). As described herein, this reset to zero behavior may be achieved by counter wrap-around, if the RRC counter width matches the IV-LSB width. The operation may continue at operation 560.

Continuing with the example depicted in FIG. 4B, if M_EVEN RRC is not equal to the predetermined maximum number (e.g., 2¹¹) (i.e., the RRC for the prior active epoch has not yet reached the maximum, as in decision 554), the operation may continue at operation 560.

The system updates, by the responder, the state of the received transaction number in the second state machine (operation 560). In the example of FIG. 4B, subsequent to incrementing M_EVEN RRC if the received request was associated with an even epoch, the responder may update the state for the IV-LSB in the state machine to ExpectOdd (as depicted above in relation to ExpOdd state 482 in FIG. 4B). Furthermore, subsequent to incrementing M_ODD RRC if the received request was associated with an odd epoch, the responder may the state for the IV-LSB in the state machine to ExpectEven (as depicted above in relation to ExpEven state 480 in FIG. 4B).

The system decrypts, by the responder, the request based on the shared key and the constructed full IV (operation 562). For example, the responder may receive an encrypted request and decrypt that request using the shared key and the constructed full IV (as constructed in operations 540/542 in FIG. 5B.

The system sends, by the responder to the requester in response to the request, a response encrypted based on the shared key and the constructed full IV (operation 564). The responder may also generate or obtain a response to the request and encrypt that response using the same shared key and constructed full IV used to decrypt the request. The responder may also send to the requester the encrypted response, which is in response to the encrypted request. The operation returns.

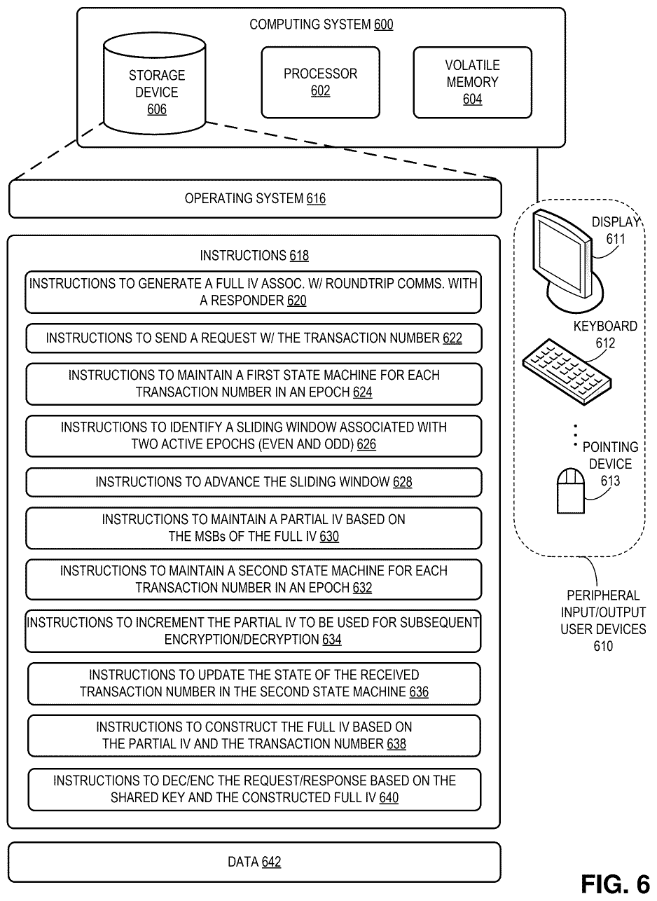

FIG. 6 illustrates a computing system 600 which facilitates sliding-window based order relaxation for an encrypted channel based on a two-epoch system, in accordance with an aspect of the present application. Computing system 600 includes a processor 602, a memory 604, and a storage device 606. Memory 604 may include a volatile memory (e.g., random access memory (RAM)) that serves as a managed memory and can be used to store one or more memory pools. Furthermore, computing system 600 may be coupled to peripheral I/O user devices 610 (e.g., a display device 611, a keyboard 612, and a pointing device 613). Storage device 606 includes non-transitory computer-readable storage medium and stores an operating system 616, instructions 618, and data 642. Computing system 600 may include fewer or more entities or instructions than those shown in FIG. 6.

Instructions 618, when executed by computing system 600, can cause computing system 600 to perform methods and/or processes described in this disclosure. Instructions 618 may include instructions performed by a requester (or by requester functionality in computing system 600), e.g., instructions 620-628. Instructions 618 may also include instructions performed by a responder (or by responder functionality in computing system 600), e.g., instructions 630-640. Specifically, instructions 618 may include instructions 620 to generate, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker. Generating the full IV is described above in relation to FIGS. 2A-B and operation 502 of FIG. 5A.

Instructions 618 may include instructions 622 to send, by the requester to the responder, a request comprising the transaction number, as described above in relation to FIGS. 2A-B, responder state diagram 479 of FIG. 4B, and operation 504 of FIG. 5A.

Instructions 618 may include instructions 624 to maintain, by the requester, a first state machine for each transaction number in an epoch, the first state machine tracking request issuance and response status for a respective transaction number across multiple epochs, as described above in relation to state machine diagrams 426 and 450 of FIGS. 4A and 4B, and operation 506 of FIG. 5A.

Instructions 618 may include instructions 626 to identify, by the requester based on the first state machine, a sliding window associated with: two active epochs including one active even epoch and one active odd epoch, a respective active epoch corresponding to a time window in which a maximum number of requests are currently allowed to be sent. A sliding window associated with an active even epoch and an active odd epoch, is described above in relation to sliding window 320 in FIG. 3. Identifying the sliding window is further described above in relation to operation 508 of FIG. 5A.

Instructions 618 may include instructions 628 to advance the sliding window by setting an oldest active epoch to an inactive epoch and by setting the inactive next epoch to an active epoch, as described above in relation to sliding window 320 in FIG. 3 and operation 514 of FIG. 5A.

Instructions 618 may include instructions 630 to maintain, by the responder, a partial IV comprising a responder epoch value based on the MSBs of the full IV, a least significant bit (LSB) of the partial IV comprising an epoch-identifying bit, as described above in relation to operation 532 of FIG. 5B.

Instructions 618 may include instructions 632 to maintain, by the responder, a second state machine for each transaction number in an epoch, the second state machine indicating two states based on whether a request is expected to be received by the responder in an even epoch or an odd epoch. The second state machine is described above in relation to state diagram 479 in FIG. 4B and operation 534 of FIG. 5B.

Instructions 618 may include instructions 634 to increment, by the responder, the partial IV to be used for subsequent decryption of the request and encryption of the response in response to determining that the epoch-identifying bit of the partial IV and the state of the received transaction number in the second state machine are not both associated with an even epoch or an odd epoch. Incrementing the responder epoch number may be based on satisfying two conditions, as described above in relation to decision 538 and operations 540/542 of FIG. 5B.

Instructions 618 may include instructions 636 to update, by the responder, the state of the received transaction number in the second state machine, as described above in relation to operation 560 of FIG. 5C.

Instructions 618 may include instructions 638 to construct, by the responder, the full IV based on the partial IV, whether incremented or not, and the received transaction number, as described above in relation to decision 538 and operations 540/542 of FIG. 5B.

Instructions 618 may include instructions 640 to decrypt the request and to encrypt the response, by the responder, based on a shared key and the constructed full IV, as described above in relation to operations 562 and 564 of FIG. 5C.

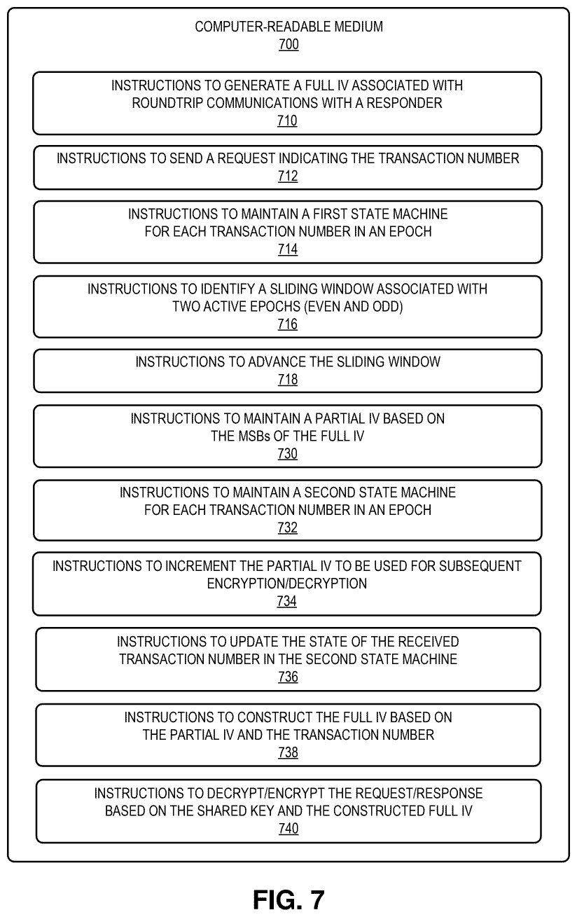

Instructions 618 may include more instructions than those shown in FIG. 6. For example, instructions 618 may include instructions for executing the operations described above in relation to: the bit-fields chart and hardware of FIGS. 2A-D; the sliding windows of FIG. 3; the per-encoding states tracked by requester and responder in FIGS. 4A-B; the operations in FIGS. 5A-C; and the instructions of CRM 700 in FIG. 7.

Data 642 can include any data that is required as input or that is generated as output by the methods, operations, communications, and/or processes described in this disclosure. Specifically, data 642 can store at least: a request; an initial value; a full IV; a partial IV; a transaction number; MSBs; LSBs; an IV-MSB; an IV-LSB; an epoch value; an epoch-identifying bit; an identifier or indicator of an epoch corresponding to a time window in which a certain number of requests may be sent; an indicator of an active or inactive epoch; a shared key; non-counter fields; counter fields; a sequentially updated full counter value; a non-sequentially updated transaction number; a state machine; a 1-bit state machine; two states for each encoding or transaction number in the 1-bit state machine; a 2-bit state machine; four states for each encoding or transaction number in the 2-bit state machine; an encrypted or decrypted request or response; a response; an indicator of an active epoch, an inactive epoch, an even epoch, or an odd epoch; a sliding window associated with epochs; a predetermined or maximum number; a number of outstanding responses; a number of requests sent in an epoch; and a number of corresponding responses received in an epoch; an outstanding request counter for an even or an odd epoch (N_EVEN ORC or N_ODD ORC); and a requests received counter for an even or an odd epoch (M_EVEN RRC or M_ODD RRC).

FIG. 7 illustrates a computer-readable medium 700 which facilitates sliding-window based order relaxation for an encrypted channel based on a two-epoch system, in accordance with an aspect of the present application. CRM 700 can be a non-transitory computer-readable medium or device storing instructions that when executed by a computer or processor cause the computer or processor to execute the instructions or perform a method. CRM 700 may store instructions performed by a requester (or by requester functionality in CRM 700), e.g., instructions 710-718. CRM 700 may also store instructions performed by a responder (or by responder functionality in CRM 700), e.g., instructions 730-740.

CRM 700 may store instructions 710 to generate, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker. Generating the full IV is described above in relation to FIGS. 2A-B and operation 502 of FIG. 5A.

CRM 700 may store instructions 712 to send, by the requester to the responder, a request comprising the transaction number, as described above in relation to FIGS. 2A-B, responder state diagram 479 of FIG. 4B, and operation 504 of FIG. 5A.

CRM 700 may store instructions 714 to maintain, by the requester, a first state machine for each transaction number in an epoch, the first state machine tracking request issuance and response status for a respective transaction number across multiple epochs, as described above in relation to state machine diagrams 426 and 450 of FIGS. 4A and 4B, and operation 506 of FIG. 5A.

CRM 700 may store instructions 716 to identify, by the requester based on the first state machine, a sliding window associated with: two active epochs including one active even epoch and one active odd epoch, a respective active epoch corresponding to a time window in which a maximum number of requests are currently allowed to be sent. A sliding window associated with an active even epoch and an active odd epoch, is described above in relation to sliding window 320 in FIG. 3. Identifying the sliding window is further described above in relation to operation 508 of FIG. 5A.

CRM 700 may store instructions 718 to advance the sliding window by setting an oldest active epoch to an inactive epoch and by setting the inactive next epoch to an active epoch, as described above in relation to sliding window 320 in FIG. 3 and operation 514 of FIG. 5A.

CRM 700 may store instructions 730 to maintain, by the responder, a partial IV comprising a responder epoch value based on the MSBs of the full IV, a least significant bit (LSB) of the partial IV comprising an epoch-identifying bit, as described above in relation to operation 532 of FIG. 5B.

CRM 700 may store instructions 732 to maintain, by the responder, a second state machine for each transaction number in an epoch, the second state machine indicating two states based on whether a request is expected to be received by the responder in an even epoch or an odd epoch. The second state machine is described above in relation to state diagram 479 in FIG. 4B and operation 534 of FIG. 5B.

CRM 700 may store instructions 734 to increment, by the responder, the partial IV to be used for subsequent decryption of the request and encryption of the response in response to determining that the epoch-identifying bit of the partial IV and the state of the received transaction number in the second state machine are not both associated with an even epoch or an odd epoch. Incrementing the responder epoch number may be based on satisfying two conditions, as described above in relation to decision 538 of FIG. 5B and operations 540/542 of FIG. 5B.

CRM 700 may store instructions 736 to update, by the responder, the state of the received transaction number in the second state machine, as described above in relation to operation 560 of FIG. 5C.

CRM 700 may store instructions 738 to construct, by the responder, the full IV based on the partial IV, whether incremented or not, and the received transaction number, as described above in relation to decision 538 and operations 54/0/542 of FIG. 5B.

CRM 700 may store instructions 740 to decrypt the request and to encrypt the response, by the responder, based on a shared key and the constructed full IV, as described above in relation to operations 562 and 564 of FIG. 5C.

CRM 700 may include more instructions than those shown in FIG. 7.

For example, CRM 800 may also store instructions for executing the operations described above in relation to: the bit-field charts and hardware of FIGS. 2A-D; the sliding windows of FIG. 3; the per-encoding states tracked by requester and responder in FIGS. 4A-B; the operations in FIGS. 5A-C; and the instructions in computing system 600 of FIG. 6.

The term “network device” refers to any device, component, or computing entity which can provide a communication pipeline for packets sent from a “processing node” or an “endpoint node.” An example of a network device may be a switch, as described above in relation to FIG. 1. A processing or endpoint node may refer to a device, component, or hardware component which can operate as a source or a destination of data, including e.g., a control packet or a data packet. A processing node or endpoint node may be referred to as a “requester” or a “responder.” A requester and a responder may transmit data (e.g., a request or a response) to each other over the communication pipeline as a roundtrip communication. The requester may generate and send an encrypted request to the responder. The responder may decrypt the request, generate a response, and send an encrypted response back to the requester. The requester may subsequently decrypt the response. Accordingly, the requester and the responder may each be an endpoint for data sent across the communication pipeline (e.g., a network fabric such as fabric 110 in FIG. 1). Additionally, an endpoint node or processing node may serve as both a requester and a responder. That is, an endpoint or processing node may include both requester functionality and responder functionality, as described herein, including in, e.g.: FIGS. 2A-D depicting bit-field charts and hardware maintained by each of the requester and the responder. Instructions 618 including requester functionality in instructions 620-628 and responder functionality in instructions 630-640; and instructions in CRM 700 including requester functionality in instructions 710-718 and responder functionality in instructions 730-740.

In general, the disclosed aspects provide a method, a computing system, and a computer-readable medium which facilitate sliding-window based order relaxation for an encrypted channel based on a two-epoch system. The system generates, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker. The system sends, by the requester to the responder, a request comprising the transaction number. The system maintains, by the requester, a first state machine for each transaction number in an epoch, the first state machine tracking request issuance and response status for a respective transaction number across multiple epochs. The system identifies, by the requester based on the first state machine, a sliding window associated with: two active epochs including one active even epoch and one active odd epoch, a respective active epoch corresponding to a time window in which a maximum number of requests are currently allowed to be sent. The system advances the sliding window by setting an oldest active epoch to an inactive epoch and by setting the next inactive next epoch to an active epoch.

In a variation on this aspect, the requester epoch value identifies alternating even epochs and odd epochs. A respective epoch is associated with the maximum number of requests allowed to be sent out of order by the requester to the responder.

In a further variation on this aspect, the system encrypts the request based on a shared key and the full IV. In response to sending the request: the requester increments a number of requests awaiting a response in the even epoch or the odd epoch; and the requester updates a state of the sent transaction number in the first state machine. The requester receives a response in response to sending the request to the responder. The requester decrements the number of requests awaiting a response in the even epoch or the odd epoch. The requester decrypts the response based on the shared key and the full IV used by the requester to encrypt the request.

In a further variation, advancing the sliding window comprises incrementing, by the requester, the requester epoch value in response to: determining that requests have been issued for all transaction numbers in a most recent active epoch; and determining that all outstanding requests have received a corresponding response in the oldest active epoch.

In a further variation, the first state machine indicates four states for a respective transaction number, the four states comprising at least one of: an Issuable Even state in which a request may be issued in an even epoch for the respective transaction number if there are no more outstanding requests in the prior even epoch; an Outstanding Even state in which a request in the even epoch for the respective transaction number has been issued but is still awaiting a response; an Issuable Odd state in which a request may be issued in an odd epoch for the respective transaction number if there are no more outstanding requests in the prior odd epoch; or an Outstanding Odd state in which a request in the odd epoch for the respective transaction number has been issued but is still awaiting a response.

In a further variation, the system maintains, by the responder, a partial IV comprising a responder epoch value based on the MSBs of the full IV, a least significant bit (LSB) of the partial IV comprising an epoch-identifying bit. The system maintains, by the responder, a second state machine for each transaction number in an epoch, the second state machine indicating two states based on whether a request is expected to be received by the responder in an even epoch or an odd epoch. The system receives, by the responder, the request including the header field indicating the transaction number.

In a further variation, the responder determines whether the epoch-identifying bit of the partial IV and the state of the received transaction number in the second state machine are both associated with an even epoch or an odd epoch. The responder increments the partial IV to be used for subsequent decryption of the request and encryption of the response in response to determining that the epoch-identifying bit of the partial IV and the state of the received transaction number in the second state machine are not both associated with an even epoch or an odd epoch.

In a further variation, the system increments, by the responder, a number of requests received in the even epoch or the odd epoch. The system updates, by the responder, the state of the received transaction number in the second state machine. The system constructs, by the responder, the full IV based on the partial IV, whether incremented or not, and the received transaction number. The system decrypts, by the responder, the request based on a shared key and the constructed full IV. The system sends, by the responder to the requester in response to the request, a response encrypted based on the shared key and the constructed full IV.

In a further variation, the responder increments the responder epoch value in response to the number of requests received in the even epoch or the odd epoch reaching the maximum number.

In a further variation, the request indicates the transaction number in a header field comprising at least one of a protocol layer field or a protocol Tag field. The header field indicates the transaction number is not encrypted.

In a further variation, the LSBs indicating the transaction number in the full IV comprise 11 bits. The maximum transaction number is 2¹¹. The twelfth bit of the requester epoch value indicates whether the request is sent during an even epoch or an odd epoch.

In another aspect, a computing system comprises a processing resource and a storage device storing instructions which when executed by the processing resource cause the processing resource to perform a method, e.g., instructions 718 in FIG. 7. The instructions or method may be performed by a requester or a responder. The instructions are to generate, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker. The instructions are further to send, by the requester to the responder, a request comprising the transaction number. The instructions are further to maintain, by the requester, a first state machine for each transaction number in an epoch, the first state machine tracking request issuance and response status for a respective transaction number across multiple epochs. The instructions are further to identify, by the requester based on the first state machine, a sliding window associated with: two active epochs including one active even epoch and one active odd epoch, a respective active epoch corresponding to a time window in which a maximum number of requests are currently allowed to be sent. The instructions are further to advance the sliding window by setting an oldest active epoch to an inactive epoch and by setting the next inactive next epoch to an active epoch.

The instructions are further to maintain, by the responder, a partial IV comprising a responder epoch value based on the MSBs of the full IV, a least significant bit (LSB) of the partial IV comprising an epoch-identifying bit. The instructions are further to maintain, by the responder, a second state machine for each transaction number in an epoch, the second state machine indicating two states based on whether a request is expected to be received by the responder in an even epoch or an odd epoch. The instructions are further to receive, by the responder, the request including the header field indicating the transaction number. The instructions are further to increment, by the responder, the partial IV to be used for subsequent decryption of the request and encryption of the response in response to determining that an epoch-identifying bit of the partial IV and the state of the received transaction number in the second state machine are not both associated with an even epoch or an odd epoch. The instructions are further to increment, by the responder, a number of requests received in the even epoch or the odd epoch. The instructions are further to update, by the responder, the state of the received transaction number in the second state machine. The instructions are further to construct, by the responder, the full IV based on the partial IV, whether incremented or not, and the received transaction number. The instructions are further to decrypt, by the responder, the request based on a shared key and the constructed full IV. The instructions are further to send, by the responder to the requester in response to the request, a response encrypted based on the shared key and the constructed full IV.

The computing system may also include additional instructions, including in relation to: the bit-field charts and hardware of FIGS. 2A-D; the sliding windows of FIG. 3; the per-encoding states tracked by requester and responder in FIGS. 4A-B; the operations in FIGS. 5A-C; and the instructions of CRM 700 in FIG. 7.

In another aspect, a non-transitory computer-readable storage medium (or CRM) stores instructions to perform a method. The instructions or method may be performed by a requester or a responder and may be similar to the instructions described above for the computing system. The CRM may also include additional instructions, including in relation to: the bit-field charts and hardware of FIGS. 2A-D; the sliding windows of FIG. 3; the per-encoding states tracked by requester and responder in FIGS. 4A-B; the operations in FIGS. 5A-C; and the instructions in computing system 600 of FIG. 6.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
generating, by a requester in a network fabric, a full initial value (IV) associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker;
sending, by the requester to the responder, a request comprising the transaction number;
maintaining, by the requester, a first state machine for each transaction number in an epoch, the first state machine tracking request issuance and response status for a respective transaction number across multiple epochs;
identifying, by the requester based on the first state machine, a sliding window associated with two active epochs including one active even epoch and one active odd epoch, a respective active epoch corresponding to a time window in which a maximum number of requests are currently allowed to be sent; and
advancing the sliding window by setting an oldest active epoch to an inactive epoch and by setting an inactive next epoch to an active epoch.

2. The method of claim 1,
wherein the requester epoch value identifies alternating even epochs and odd epochs; and
wherein a respective epoch is associated with the maximum number of requests allowed to be sent out of order by the requester to the responder.

3. The method of claim 1, further comprising:
encrypting the request based on a shared key and the full IV;
in response to sending the request:
incrementing, by the requester, a number of requests awaiting a response in the even epoch or the odd epoch; and
updating, by the requester, a state of the sent transaction number in the first state machine;
receiving a response in response to sending the request to the responder;
decrementing the number of requests awaiting a response in the even epoch or the odd epoch; and
decrypting the response based on the shared key and the full IV used by the requester to encrypt the request.

4. The method of claim 1,
wherein advancing the sliding window comprises incrementing, by the requester, the requester epoch value in response to:
determining that requests have been issued for all transaction numbers in a most recent active epoch; and
determining that all outstanding requests have received a corresponding response in the oldest active epoch.

5. The method of claim 1, wherein the first state machine indicates four states for a respective transaction number, the four states comprising at least one of:
an Issuable Even state in which a request may be issued in an even epoch for the respective transaction number if there are no more outstanding requests in the prior even epoch;
an Outstanding Even state in which a request in the even epoch for the respective transaction number has been issued but is still awaiting a response;
an Issuable Odd state in which a request may be issued in an odd epoch for the respective transaction number if there are no more outstanding requests in the prior odd epoch; or
an Outstanding Odd state in which a request in the odd epoch for the respective transaction number has been issued but is still awaiting a response.

6. The method of claim 1, further comprising:
maintaining, by the responder, a partial IV comprising a responder epoch value based on the MSBs of the full IV, a least significant bit (LSB) of the partial IV comprising an epoch-identifying bit;
maintaining, by the responder, a second state machine for each transaction number in an epoch, the second state machine indicating two states based on whether a request is expected to be received by the responder in an even epoch or an odd epoch; and
receiving, by the responder, the request including the header field indicating the transaction number.

7. The method of claim 6, further comprising:
determining whether the epoch-identifying bit of the partial IV and the state of the received transaction number in the second state machine are both associated with an even epoch or an odd epoch; and
incrementing, by the responder, the partial IV to be used for subsequent decryption of the request and encryption of the response in response to determining that the epoch-identifying bit of the partial IV and the state of the received transaction number in the second state machine are not both associated with an even epoch or an odd epoch.

8. The method of claim 7, further comprising:
incrementing, by the responder, a number of requests received in the even epoch or the odd epoch;
updating, by the responder, the state of the received transaction number in the second state machine;
constructing, by the responder, the full IV based on the partial IV, whether incremented or not, and the received transaction number;
decrypting, by the responder, the request based on a shared key and the constructed full IV; and
sending, by the responder to the requester in response to the request, a response encrypted based on the shared key and the constructed full IV.

9. The method of claim 8, further comprising:
incrementing the responder epoch value in response to the number of requests received in the even epoch or the odd epoch reaching the maximum number.

10. The method of claim 1,
wherein the request indicates the transaction number in a header field comprising at least one of a protocol layer field or a protocol Tag field, and
wherein the header field indicating the transaction number is not encrypted.

11. The method of claim 1,
wherein the LSBs indicating the transaction number in the full IV comprise bits,
wherein the maximum transaction number is 2¹¹, and
wherein the twelfth bit of the requester epoch value indicates whether the request is sent during an even epoch or an odd epoch.

12. A computing system comprising:
a processing resource; and
a storage device storing instructions which when executed by the processing resource cause the processing resource to perform a method, the method comprising:
generating, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker;
sending, by the requester to the responder, a request comprising the transaction number;
maintaining, by the requester, a first state machine for each transaction number in an epoch, the first state machine tracking request issuance and response status for a respective transaction number across multiple epochs;
identifying, by the requester based on the first state machine, a sliding window associated with two active epochs including one active even epoch and one active odd epoch, a respective active epoch corresponding to a time window in which a maximum number of requests are currently allowed to be sent; and
advancing the sliding window by setting an oldest active epoch to an inactive epoch and by setting an inactive next epoch to an active epoch.

13. The computing system of claim 12,
wherein the request indicates the transaction number in a header field comprising at least one of a protocol layer field or a protocol Tag field;
wherein the requester epoch value identifies alternating even epochs and odd epochs;
wherein a respective epoch is associated with the maximum number of requests allowed to be sent out of order by the requester to the responder;
wherein the first state machine indicates, for a respective transaction, four states based on:
whether a request may have be issued in a most recent active even or odd epoch; and
whether all outstanding requests have received a corresponding response in the oldest active even or odd epoch; and
wherein advancing the sliding window comprises incrementing, by the requester, the requester epoch value in response to:
determining that requests have been issued for all transaction numbers in a most recent active epoch; and
determining that all outstanding requests have received a corresponding response in the oldest active epoch.

14. The computing system of claim 12, wherein the method further comprises:
encrypting the request based on a shared key and the full IV;
in response to sending the request:
incrementing, by the requester, a number of requests awaiting a response in the even epoch or the odd epoch; and
updating, by the requester, a state of the sent transaction number in the first state machine;
receiving a response in response to sending the request to the responder;
decrementing the number of requests awaiting a response in the even epoch or the odd epoch; and
decrypting the response based on the shared key and the full IV used by the requester to encrypt the request.

15. The computing system of claim 12, wherein the method further comprises:
maintaining, by the responder, a partial IV comprising a responder epoch value based on the MSBs of the full IV, a least significant bit (LSB) of the partial IV comprising an epoch-identifying bit;
maintaining, by the responder, a second state machine for each transaction number in an epoch, the second state machine indicating two states based on whether a request is expected to be received by the responder in an even epoch or an odd epoch;
receiving, by the responder, the request including the header field indicating the transaction number;
incrementing, by the responder, the partial IV to be used for subsequent decryption of the request and encryption of the response in response to determining that an epoch-identifying bit of the partial IV and the state of the received transaction number in the second state machine are not both associated with an even epoch or an odd epoch;
incrementing, by the responder, a number of requests received in the even epoch or the odd epoch;
updating, by the responder, the state of the received transaction number in the second state machine;
constructing, by the responder, the full IV based on the partial IV, whether incremented or not, and the received transaction number;
decrypting, by the responder, the request based on a shared key and the constructed full IV; and
sending, by the responder to the requester in response to the request, a response encrypted based on the shared key and the constructed full IV.

16. The computing system of claim 12,
wherein the maximum number of requests allowed to be sent in a given epoch is based on a number of bits allocated to the transaction number in the full IV.

17. A non-transitory computer-readable medium storing instructions which when executed by a processing resource cause the processing resource to perform a method, the method comprising:
generating, by a requester in a network fabric, a full IV associated with encryption of round-trip communications with a responder, the full IV comprising most significant bits (MSBs) indicating a requester epoch value to be incremented sequentially by the requester and least significant bits (LSBs) indicating a transaction number to be updated non-sequentially by a free-space tracker;
sending, by the requester to the responder, a request comprising the transaction number;
maintaining, by the requester, a first state machine for each transaction number in an epoch, the first state machine tracking request issuance and response status for a respective transaction number across multiple epochs;
identifying, by the requester based on the first state machine, a sliding window associated with two active epochs including one active even epoch and one active odd epoch, a respective active epoch corresponding to a time window in which a maximum number of requests are currently allowed to be sent; and
advancing the sliding window by setting an oldest active epoch to an inactive epoch and by setting an inactive next epoch to an active epoch.

18. The non-transitory computer-readable medium of claim 17,
wherein the request indicates the transaction number in a header field comprising at least one of a protocol layer field or a protocol Tag field;
wherein the requester epoch value identifies alternating even epochs and odd epochs;
wherein a respective epoch is associated with the maximum number of requests allowed to be sent out of order by the requester to the responder;
wherein the first state machine indicates, for a respective transaction, four states based on:
whether a request may have be issued in a most recent active even or odd epoch; and
whether all outstanding requests have received a corresponding response in the oldest active even or odd epoch; and
wherein advancing the sliding window comprises incrementing, by the requester, the requester epoch value in response to:
determining that requests have been issued for all transaction numbers in a most recent active epoch; and
determining that all outstanding requests have received a corresponding response in the oldest active epoch.

19. The non-transitory computer-readable medium of claim 17, wherein the method further comprises:
maintaining, by the responder, a partial IV comprising a responder epoch value based on the MSBs of the full IV, a least significant bit (LSB) of the partial IV comprising an epoch-identifying bit;
maintaining, by the responder, a second state machine for each transaction number in an epoch, the second state machine indicating two states based on whether a request is expected to be received by the responder in an even epoch or an odd epoch;
receiving, by the responder, the request including the header field indicating the transaction number; and
incrementing, by the responder, the partial IV to be used for subsequent decryption of the request and encryption of the response in response to determining that an epoch-identifying bit of the partial IV and the state of the received transaction number in the second state machine are not both associated with an even epoch or an odd epoch.

20. The non-transitory computer-readable medium of claim 19, wherein the method further comprises:
incrementing, by the responder, a number of requests received in the even epoch or the odd epoch;
updating, by the responder, the state of the received transaction number in the second state machine;
constructing, by the responder, the full IV based on the partial IV, whether incremented or not, and the received transaction number;
decrypting, by the responder, the request based on a shared key and the constructed full IV; and
sending, by the responder to the requester in response to the request, a response encrypted based on the shared key and the constructed full IV.
